(19) United States
(12) Patent Application Publication
(10) Pub. No.: US 2019/0122568 A1
(43) Pub. Date: Apr. 25, 2019

(54) AUTONOMOUS VEHICLE OPERATION

(71) Applicant: AIRDOG, INC., Dover, DE (US)

(72) Inventors: Ilja Nevdahs, Riga (LV); Agris Kipurs, Jelgava (LV); Edgars Rozentals, Riga (LV)

(73) Assignee: AIRDOG, INC., Dover, DE (US)

(21) Appl. No.: 16/158,144

(22) Filed: Oct. 11, 2018

Related U.S. Application Data
(60) Provisional application No. 62/544,637, filed on Aug. 11, 2017.

(51) Int. Cl. G08G 5/00; G05D 1/10; B64C 39/02

(52) U.S. Cl. CPC G08G 5/0069; B64C 2201/141; B64C 39/024; G05D 1/101

(57) ABSTRACT

A method for an autonomous vehicle to follow a target may include obtaining a three dimensional virtual cable for an autonomous vehicle and obtaining a position and a velocity of a target. Additionally, the method may include obtaining a position of an autonomous vehicle and determining a calculated position of the autonomous vehicle based on the position and velocity of the target and based on the three dimensional virtual cable. The method may also include determining a velocity vector magnitude for the autonomous vehicle based on the calculated position, the position of the autonomous vehicle, and the three dimensional virtual cable. The method may further include determining a velocity vector for the autonomous vehicle based on the velocity vector magnitude and a line gravity vector. The method may also include adjusting a velocity and a direction of the autonomous vehicle based on the velocity vector.

### FIELD

The embodiments discussed herein relate to autonomous vehicle operation.

### BACKGROUND

Autonomous vehicles, such as drones, may be used to obtain information, such as photographs and video, of objects. For example, drones have been used by militaries to fly over selected objects following preselected and particular flight paths and obtain pictures and videos of the objects.

The subject matter claimed herein is not limited to embodiments that solve any disadvantages or that operate only in environments such as those described above. Rather, this background is only provided to illustrate one example technology area where some embodiments described herein may be practiced.

### SUMMARY

One aspect of the present disclosure includes a method for an autonomous vehicle to follow a target may include obtaining a three dimensional virtual cable for an autonomous vehicle and obtaining a position and a velocity of a target. Additionally, the method may include obtaining a position of an autonomous vehicle and determining a calculated position of the autonomous vehicle based on the position and velocity of the target and based on the three dimensional virtual cable. The method may also include determining a velocity vector magnitude for the autonomous vehicle based on the calculated position, the position of the autonomous vehicle, and the three dimensional virtual cable. The method may further include determining a velocity vector for the autonomous vehicle based on the velocity vector magnitude and a line gravity vector. The method may also include adjusting a velocity and a direction of the autonomous vehicle based on the velocity vector.

According to another aspect of the present disclosure, system operations and/or a method to generate a three dimensional virtual cable for an autonomous vehicle may include obtaining a first position of a first set point for the three dimensional virtual cable, obtaining a first altitude for the first set point, and obtaining a second position for a second set point. Additionally, the system operations and/or the method may include obtaining a second altitude for the second set point, connecting the first set point with the second set point with a first line, and obtaining a third position for a third set point. The system operations and/or the method may also include obtaining a third altitude for the third set point, connecting the second set point with the third set point with a second line, and storing the first set point with the first position and the first altitude, the second set point with the second position and the second altitude, the third set point with the third position and the third altitude, the first line, and the second line in one or more computer-readable media.

### BRIEF DESCRIPTION OF THE DRAWINGS

Example embodiments will be described and explained with additional specificity and detail through the use of the accompanying drawings in which:

FIG. 1 illustrates an example system for following a target;

FIG. 2 is a block diagram of an example autonomous vehicle processing system;

FIG. 3 is a diagram representing an example embodiment related to generating an autonomous vehicle position on a 3D line;

FIG. 4 is a diagram representing an example embodiment related to generating a velocity vector magnitude;

FIG. 5 is a diagram representing an example embodiment related to generating a velocity vertical component correction;

FIG. 6 is a diagram representing an example embodiment related to generating a velocity vector;

FIG. 7 is a diagram representing an example environment related to generating a 3D line on a user device; and

FIG. 8 is a diagram representing another example environment related to generating a 3D line on a user device.

### DESCRIPTION OF EMBODIMENTS

Some embodiments described in this description relate to an autonomous vehicle configured to follow a moving target in close proximity while capturing images or videos of the target. In some embodiments, the autonomous vehicle may be configured to avoid obstacles while following the moving target. In these and other embodiments, obstacle meta-data that defines an obstacle may be stored onboard the autonomous vehicle, wirelessly fetched from another device, or obtained in real time from sensors of the autonomous vehicle.

In some embodiments, the autonomous vehicle may refer to a flying unmanned aerial vehicle or system (UAV/UAS), a drone, an unmanned ground vehicle, an unmanned water vehicle, or any other type of autonomous vehicle.

In some embodiments, methods and/or systems described in this disclosure may uses real time position information about a target; an autonomous vehicle, and a sensor payload on the autonomous vehicle; orientation and motion data of the target, the autonomous vehicle, and the sensor payload; meta-data describing nearby obstacles; and particular following algorithms to generate steering and/or orientation commands for the autonomous vehicle and the sensor payload. The steering and/or orientation commands may allow the autonomous vehicle and/or the sensor payload to follow a target at a particular proximity and to obtain different photographic images or video images or obtain other data acquisition concerning the target.

In some embodiments, the particular following algorithms may include a set of movement algorithms that define autonomous vehicle behavior and target following patterns. These target following patterns may be referred to in this disclosure as target following modes. The target following modes may be user configurable and/or may be selected implicitly by a user or automatically by the autonomous vehicle depending on a position, a velocity, and/or a directional trajectory of a target with respect to a position, a velocity, and/or a directional trajectory of the autonomous vehicle.

In some embodiments, a target may be tracked by a tracking device such as a dedicated motion tracker device, smart phone, or other device. Alternately or additionally, a target may be tracked by detecting a position, a velocity, and/or a directional trajectory of the target with sensors, such as computer vision cameras, radars, or lasers of the autonomous vehicle.

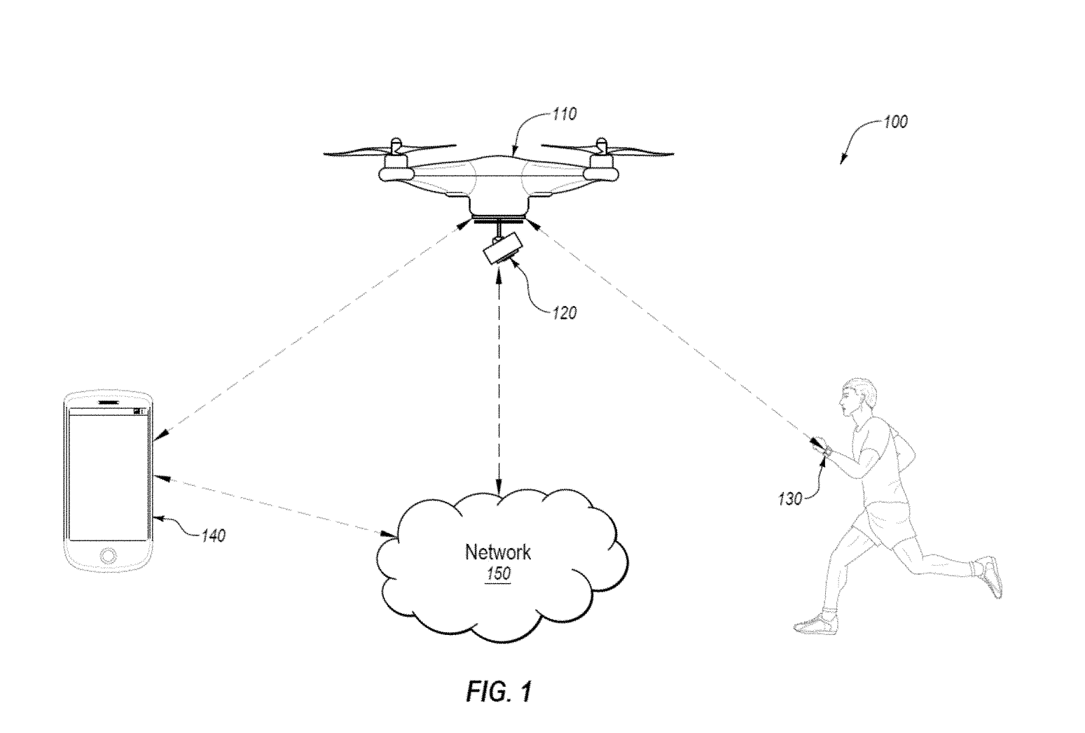

FIG. 1 illustrates an example system 100 for following a target, arranged in accordance with at least one embodiment described in this disclosure. In some embodiments, the system 100 may include an autonomous vehicle 110 that includes a sensor payload 120, a motion tracking device 130, a computing device 140, and a data storage 150.

The autonomous vehicle 110 may be any type of unmanned vehicle that is configured to autonomously move according to a selected following mode. In some embodiments, the autonomous vehicle 110 autonomously moving may indicate that the autonomous vehicle 110 is selecting a direction and speed of movement based on one or more calculations determined by the autonomous vehicle 110 or some other computer source. Autonomously moving may further indicate that a human being is not directing the movements of the autonomous vehicle 110 through direct or remote control of the autonomous vehicle 110.

The autonomous vehicle 110 is depicted in FIG. 1 as a flying drone that flies through the air, but this disclosure is not limited to only flying drones. Rather the autonomous vehicle 110 may be any type of autonomous vehicle, such as a drone that travels across the ground on wheels, tracks, or some other propulsion system. Alternately or additionally, the autonomous vehicle 110 may be a water drone that travels across or under the water.

The autonomous vehicle 110 may be configured to determine and/or estimate real time location data about the autonomous vehicle 110. In some embodiments, the location data may include real time position, orientation, velocity, acceleration, and/or trajectory in 3D space of the autonomous vehicle 110. The autonomous vehicle 110 may be equipped with one or more sensors to determine the location data. The sensors may include one or more of gyroscopes, accelerometers, barometers, magnetic field sensors, and global positioning sensors, among other sensors.

The autonomous vehicle 110 may be further configured to communicate with other components of the system 100 using wireless data communications. The wireless data communications may occur using any type of one or more wireless networks. For example, the wireless networks may include BLUETOOTH® communication networks and/or cellular communications networks for sending and receiving data, or other suitable wireless communication protocol/networks (e.g., wireless fidelity (Wi-Fi), ZigBee, etc.). For example, in some embodiments, the autonomous vehicle 110 may provide its location data over a wireless network to other components of the system 100. Alternately or additionally, the autonomous vehicle 110 may receive information from other components over a wireless network. For example, the autonomous vehicle 110 may receive location data of the motion tracking device 130 over a wireless network.

The sensor payload 120 may be coupled to the autonomous vehicle 110. The sensor payload 120 may include sensors to record information about the motion tracking device 130 or a device or person associated with the motion tracking device 130. For example, the sensor payload 120 may be a camera configured to capture photographic images or video images of the motion tracking device 130 or a device or person associated with the motion tracking device 130. Alternately or additionally, the sensor payload 120 may be configured to obtain other information about the motion tracking device 130 or a device or person associated with the motion tracking device 130. In some embodiments, the sensor payload 120 may provide the image, video, and/or data to the autonomous vehicle 110. In these and other embodiments, the autonomous vehicle 110 may provide the image, video, and/or data to other components of the system 100 using wireless data communications.

In some embodiments, the sensor payload 120 may include other sensors to generate location data of a device or person. The location data may include position, orientation, velocity, acceleration, and/or trajectory of the device or person. For example, the sensor payload 120 may include an ultrasonic or laser rangefinder, radar, or other type of sensor that is configured to provide location data of a device or person separate from the sensor payload 120 and the autonomous vehicle 110. The sensor payload 120 may be configured to provide the location data to the autonomous vehicle 110. In these and other embodiments, the autonomous vehicle 110 may provide the location data to other components of the system 100 over a wireless communication network.

The motion tracking device 130 may be configured to determine and/or estimate real-time location data about the motion tracking device 130 and thus about the device or person associated with the motion tracking device 130. In some embodiments, the location data may include real-time position, orientation, velocity, acceleration, and/or trajectory in 3D space of the motion tracking device 130. The motion tracking device 130 may be equipped with one or more sensors to determine the location data. The sensors may include one or more gyroscopes, accelerometers, barometers, magnetic field sensors, and/or global positioning sensors, among other sensors.

In some embodiments, the motion tracking device 130 may be further configured to communicate with other components of the system 100 using a wireless communication network. In these and other embodiments, the motion tracking device 130 may provide its location data to the autonomous vehicle 110.

As indicated, the motion tracking device 130 may be associated with a person or device. For example, the motion tracking device 130 may be associated with a person or device based on the physical proximity of the motion tracking device 130 with the person or device. For example, the motion tracking device 130 may be associated with a person when the person is wearing the motion tracking device 130. As such, the location data of the motion tracking device 130 may be used as a substitute for the location data of the associated device or person. As such, when the motion tracking device 130 determines its location data, the motion tracking device 130 may also determine the location data of the person or the device associated with the motion tracking device 130.

In some embodiment, the motion tracking device 130 may include a user interface to allow a user of the autonomous vehicle 110 to enter and/or select operation parameters and following modes for the autonomous vehicle 110. In these and other embodiments, the motion tracking device 130 may include a touch-screen or some other user interface. In some embodiments, the user of the autonomous vehicle 110 may be the person associated with the motion tracking device 130.

The computing device 140 may be configured to communicate with the autonomous vehicle 110, the motion tracking device 130, and the data storage 150 using a wireless communication network. In some embodiments, the computing device 140 may be configured to receive data, such as location data and operating data from the autonomous vehicle 110 and the motion tracking device 130.

In some embodiments, the computing device 140 may be configured to receive data from the sensor payload 120. For example, the computing device 140 may receive images or video from the sensor payload 120.

In some embodiments, the computing device 140 may be configured to store and provide operation parameters for the autonomous vehicle 110. For example, the computing device 140 may send parameters regarding following modes or a selected following mode to the autonomous vehicle 110.

In some embodiments, the computing device 140 may include a user interface to allow a user of the autonomous vehicle 110 to enter and/or select operation parameters and following modes for the autonomous vehicle 110. In these and other embodiments, the computing device 140 may include a touch-screen or some other user interface. In these and other embodiments, the computing device 140 may be a device that performs the functionality described in this disclosure based on software being run by the computing device 140. In these and other embodiments, the computing device 140 may perform other functions as well. For example, the computing device 140 may be laptop, tablet, smartphone, or some other device that may be configured to run software to perform the operations described herein.

The data storage 150 may be a cloud-based data storage that may be accessed over a wireless communication network. In these and other embodiments, the data storage 150 may be configured to communicate with the autonomous vehicle 110, the motion tracking device 130, and the data storage 150 over the wireless communication network. In some embodiments, the data storage 150 may be configured to receive data, such as location data and operating data, from the autonomous vehicle 110 and the motion tracking device 130.

In some embodiments, the data storage 150 may be configured to store following modes and other operational parameters for the autonomous vehicle 110. In these and other embodiments, a user may select operational parameters using the computing device 140. The computing device 140 may indicate the selection of the user to the data storage 150. The data storage 150 may be configured to provide the selected operational parameters to the autonomous vehicle 110.

In some embodiments, the operational parameters may include path restriction data. In some embodiments, the path restriction data may be received from a user by way of the computing device 140. In these and other embodiments, the path restriction data may be data that indicates an area in which the user would like to confine the travel of the autonomous vehicle 110. Alternately or additionally, the path restriction data may be data that indicates an area in which the user would like the autonomous vehicle 110 to not travel, such that the autonomous vehicle 110 avoids those areas. For example, an obstacle may be in an area that may be traversed by the autonomous vehicle 110. Path restriction data may include information about the location of the obstacle. Using the path restriction data, the autonomous vehicle 110 may be able to avoid the obstacle. In some embodiments, the path restriction data may include a 3D line, also referred to as a virtual cable, which may define the path which the autonomous vehicle 110 may travel while following the target 130.

An example of the operation of the system 100 follows. The autonomous vehicle 110 may receive a following mode and operations parameters for the following mode from the computing device 140. The autonomous vehicle 110 may further receive path restriction data from the data storage 150. The autonomous vehicle 110 may be launched and begin to receive location data from the motion tracking device 130. When the location data from the motion tracking device 130 indicates that a person wearing the motion tracking device 130 is moving, the autonomous vehicle 110 may adjust its position to follow the person. Furthermore, the autonomous vehicle 110 may direct the sensor payload 120 to adjust an angle of a camera to maintain the person in a particular field of view that may be selected based on the operation parameters. In a similar manner, the autonomous vehicle 110 may continue to track and obtain video images of the person as the person moves. For example, the person may be performing some sort of sport activity, such as skiing, snowboarding, wind surfing, surfing, biking, hiking, roller blading, skate boarding, or some other activity. The autonomous vehicle 110 may follow the person based on the selected following mode, avoid obstacles and/or path restriction areas, and maintain the camera from the sensor payload 120 focused on and obtaining video of the person while the person performs the activity.

Modifications, additions, or omissions may be made to the system 100 without departing from the scope of the present disclosure. For example, in some embodiments, the system 100 may not include the data storage 150. Alternately or additionally, the system 100 may not include the computing device 140. In these and other embodiments, the autonomous vehicle 110 or the motion tracking device 130 may include a user interface. In some embodiments, the system 100 may not include the motion tracking device 130. In these and other embodiments, the sensor payload 120 may be configured to track a person or device without receiving location information of the person or device. In some embodiments, the system 100 may include multiple motion tracking devices and multiple sensor payloads. In these and other embodiments, each of the sensor payloads may be associated with one of the motion tracking devices. Alternately or additionally, the system 100 may include multiple motion tracking devices and a single sensor payload. In these and other embodiments, the single sensor payload may collect data about one or more of the multiple motion tracking devices.

Further details regarding the operation of the autonomous vehicle may be found in U.S. patent application Ser. No. 14/839,174 filed on Aug. 28, 2015 and entitled “AUTONOMOUS VEHICLE OPERATION,” which is hereby incorporated by reference in its entirety.

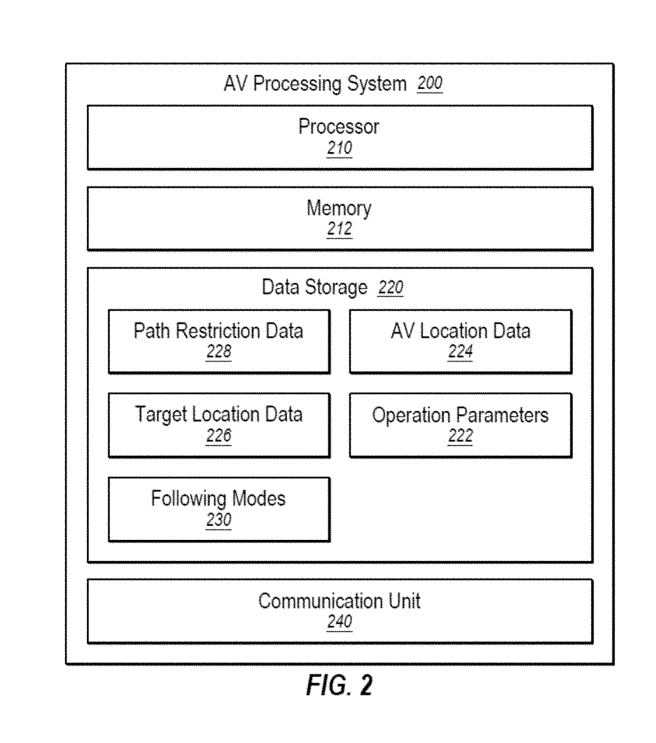

FIG. 2 is a block diagram of an example autonomous vehicle processing system, which may be arranged in accordance with at least one embodiment described in this disclosure. As illustrated in FIG. 2, the system 200 may include a processor 210, a memory 212, a data storage 220, and a communication unit 240.

Generally, the processor 210 may include any suitable special-purpose or general-purpose computer, computing entity, or processing device including various computer hardware or software modules and may be configured to execute instructions stored on any applicable computer-readable storage media. For example, the processor 210 may include a microprocessor, a microcontroller, a digital signal processor (DS), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, it is understood that the processor 210 may include any number of processors distributed across any number of network or physical locations that are configured to perform individually or collectively any number of operations described herein. In some embodiments, the processor 210 may interpret and/or execute program instructions and/or process data stored in the memory 212, the data storage 220, or the memory 212 and the data storage 220.

In some embodiments, the processor 210 may fetch program instructions and/or data from the data storage 220 and load the program instructions in the memory 212. After the program instructions and/or data are loaded into the memory 212, the processor 210 may execute the program instructions using the data. In some embodiments, executing the program instructions using the data may result in commands to control movement, location, orientation of an autonomous vehicle and/or a sensor payload of the autonomous vehicle. For example, executing the program instructions using the data may result in commands to control movement, location, and/or orientation of the autonomous vehicle 110 and the sensor payload 120 of FIG. 1.

The memory 212 and the data storage 220 may include one or more computer-readable storage media for carrying or having computer-executable instructions and/or data structures stored thereon. Such computer-readable storage media may be any available media that may be accessed by a general-purpose or special-purpose computer, such as the processor 210. By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 210 to perform a certain operation or group of operations.

The communication unit 240 may be configured to receive data that may be stored in the data storage 220 and to send data and/or instructions generated by the processor 210. For example, in some embodiments, the communication unit 240 may be configured to receive operation parameters 222 from a computing device and store the operation parameters 222 in the data storage 220. In these and other embodiments, the communication unit 240 may be configured to receive target location data 226 from a motion tracking device and store the target location data 226 in the data storage 220. In these and other embodiments, the communication unit 240 may also be configured to receive path restriction data 228 from a cloud-based data storage and AV location data 224 from sensors in the autonomous vehicle and to store the path restriction data 228 and the AV location data 224 in the data storage 220.

An example description of the operation of the system 200 follows. The operation parameters 222 may be loaded into the memory 212 and read by the processor 210. The operation parameters 222 may indicate a following mode to use. In these and other embodiments, the processor 210 may load the particular following mode 230 into the memory 212 and execute the particular following mode 230. When executing the particular following mode 230, the processor 210 may determine steering/velocity/orientation commands for the autonomous vehicle and orientation commands for the sensor payload. The processor 210 may determine the steering/velocity/orientation commands and the orientation commands based on the particular following mode 230 and data stored in the data storage 220. For example, the processor 210 may determine the steering/velocity/orientation commands and the orientation commands based on the operation parameters 222, the AV location data 224, the target location data 226, and/or the path restriction data 228.

In some embodiments, the operation parameters 222 may include data indicating a distance to maintain between the autonomous vehicle and a selected target. In some embodiments, the operation parameters 222 may include an altitude for the autonomous vehicle to maintain over the selected target. Alternately or additionally, the operation parameters 222 may include parameters for the selected following mode and estimation parameters for target position and movement.

In some embodiments, the AV location data 224 may include real-time position, orientation, velocity, acceleration, and/or trajectory in 3D space of the autonomous vehicle. In some embodiments, the target location data 226 may include real-time position, orientation, velocity, acceleration, and/or trajectory in 3D space of the target. In some embodiments, the path restriction data 228 may include locations in which the autonomous vehicle may be allowed or not allowed to traverse based on data previously obtained and stored before operation of the autonomous vehicle on a particular occasion. In these and other embodiments, the path restriction data 228 may also include information about obstacles or other objects that are sensed by the autonomous vehicle during the operation of the autonomous vehicle on this particular occasion.

The determined steering commands generated by the processor 210 may be sent by the communication unit 240 to other portions of the autonomous vehicle to steer and/or control a velocity of the autonomous vehicle. The steering commands may alter or maintain a course, position, velocity, and/or orientation of the autonomous vehicle. In some embodiments, the steering commands may alter or maintain a course, position, and/or orientation of the autonomous vehicle such that the autonomous vehicle adheres to the selected following mode with respect to the operation parameters 222 to follow the target.

The determined orientation commands generated by the processor 210 may be sent by the communication unit 240 to the sensor payload of the autonomous vehicle to control the sensor payload. The steering commands may alter or maintain a position and/or orientation of the sensor payload. In some embodiments, the orientation commands may alter or maintain the position and/or orientation of the sensor payload such that the sensor payload adheres to the selected following mode with respect to the operation parameters 222 to obtain particular data about the target, such as images, videos, and/or continuous images/videos of the target at a particular angle or view. Various following modes are discussed with respect to other figures described in this disclosure.

Modifications, additions, or omissions may be made to the system 200 without departing from the scope of the present disclosure. For example, one or more portions of the data storage 220 may be located in multiple locations and accessed by the processor 210 through a network, such as a wireless communication network.

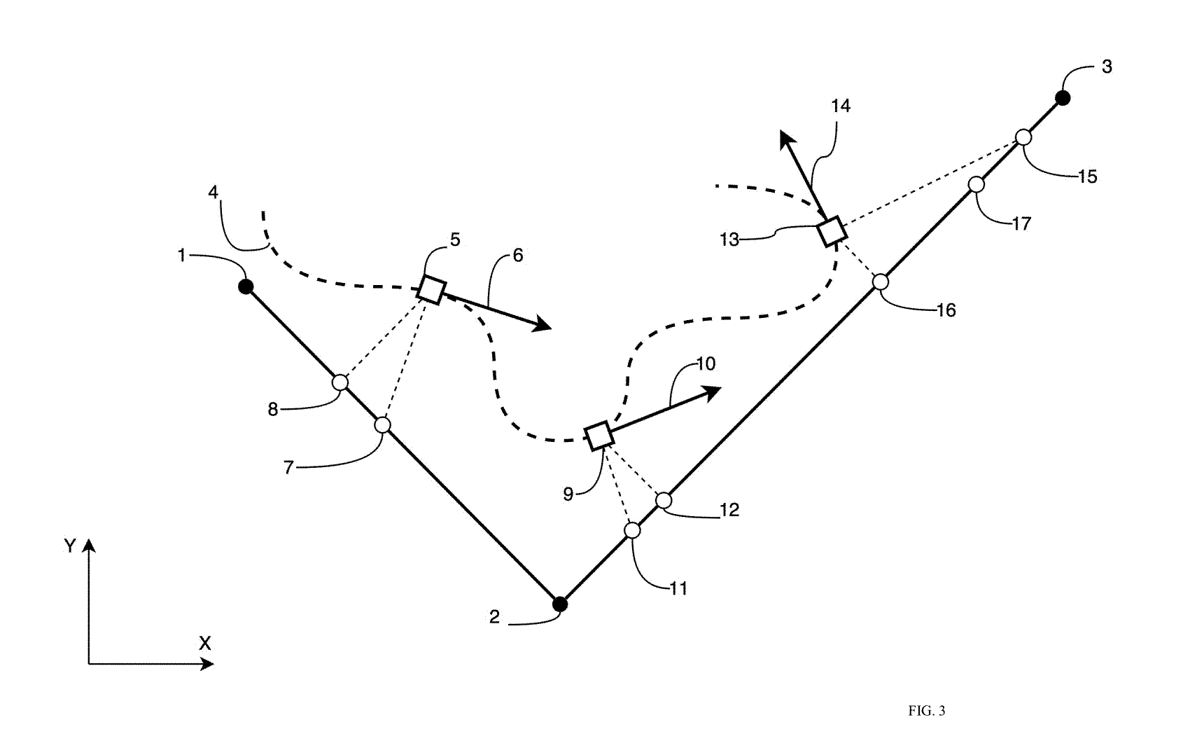

FIG. 3 illustrates a diagram representing an example embodiment related to generating an autonomous vehicle set position on a 3D line. In some embodiments, the algorithms used to calculate and control position and velocity of the autonomous vehicle may direct the autonomous vehicle to maintain a position close to a target and aim a sensor payload at the target while staying on multiple connected predefined three dimensional (3D) lines between multiple end locations (also known as a “virtual cable”). When the autonomous vehicle moves further than an allowed distance from the line, the autonomous vehicle is directed towards the position on the line closest to the current position of the autonomous vehicle. Additionally, the autonomous vehicle may be directed to maintain a position close to the target being captured, taking into account a predefined offset along the virtual cable.

The target following mode may determine a set position of the autonomous vehicle and set direction of travel along the connected predefined 3D lines with respect to a location of the target. In some embodiments, a user or system may define the multiple predefined lines and the multiple end locations. In some embodiments, the mode may include a corridor around one or more or all of the predefined lines in which the autonomous vehicle may operate instead of directly along the predefined lines. In some embodiments, a graphical map or satellite image may be used in a user interface to more easily allow a user to select the multiple end locations and the predefined lines.

For example, FIG. 3 illustrates a first line 1-2 and a second line 2-3, referred to collectively or individually as the virtual cables, that are formed by first, second, and third set locations, 1, 2, and 3, respectively. FIG. 3 further illustrates a target path 4 and first, second, and third target locations 5, 9, and 13.

In the target following mode, the location of the target may be projected onto each of the virtual cables if possible. Thus, the target in the first position 5 may be projected on the first line 1-2, the target in the second position 9 may be projected on the second line 2-3, and the target in the third position 13 may be projected on the second line 2-3.

Generally, the autonomous vehicle may move along the virtual cable to the projection that is the closest to the target. For example, in the second position 9, the target is the closest to the projection along the second line 2-3. Accordingly, the autonomous vehicle may move to the location of the projection of the target along the second line 2-3.

In some embodiments, if projection of the target does not intersect with one of the virtual cables then the distance for that virtual cable is determined based on the distance between the target and the set location that forms part of the line that is closest to the target. In these and other embodiments, if the distance from a set location is closer than a projection distance, the autonomous vehicle may move to the set location.

When the autonomous vehicle is not on one of the virtual cables, the autonomous vehicle may move to the closest line or set location and then begin tracking the target as defined above. When the projection or the particular position of the autonomous vehicle is not along the virtual cable where the autonomous vehicle is currently located, the autonomous vehicle, in some embodiments, may move directly to that location. Alternately or additionally, the autonomous vehicle may move along the different lines to the location. For example, if the autonomous vehicle is on the second line 2-3 and the particular position of the autonomous vehicle moves to the first line 1-2, the autonomous vehicle may move from the second line 2-3 to the first line 1-2 via the second set location 2 and not directly from the second line 2-3 to the first line 1-2 by deviating from the virtual cables. Modifications, additions, or omissions may be made to the target following mode without departing from the scope of the present disclosure. For example, additional lines may be added. In these and other embodiments, the lines may form a closed polynomial. Alternately or additionally, corridor boundaries may surround each of the virtual cables.

In some embodiments, the target following mode may use an array of three dimensional coordinates in representing the virtual cable. For example, the first set location 1 may be represented as [1, 1, 1], the second set location 2 may be represented as [3, 3, 3], and the third set location 3 may be represented as [100, 100, 100]. In these and other embodiments, the virtual cable may be represented as {[1, 1, 1]; [3, 3, 3]; [100, 100, 100]}. In some embodiments, the target following mode may include a closed virtual cable. For example, there may be a 3D line from the third set location to the first set location, forming a looped 3D line. In some embodiments, the target following mode may include a set offset position of the autonomous vehicle relative to the target. For example, in some embodiments, the offset position may represent a distance forward or backward of the target for the autonomous vehicle calculated position. Alternatively or additionally, in some embodiments, the target following mode may include a maximum distance for the autonomous vehicle to travel forward on the virtual cable relative to the target position and target velocity.

The target following mode may use data from the target and from the autonomous vehicle. For example, the target following mode may use pos, the current position of the autonomous vehicle in 3D space; vel, the current velocity vector of the autonomous vehicle in 3D space; t_pos, the current position of the target in 3D space; and t_vel, the current velocity vector of the target in 3D space. In some embodiments, t_pos and t_vel may be obtained from the target over radio. Alternatively or additionally, in some embodiments, t_pos and t_vel may be obtained from onboard sensors. In some embodiments, one or more variables may be corrected by applying compensation for data acquisition and/or processing delays.

The calculated position for the autonomous vehicle may be determined based on the target's positions 5, 9, and 13 over time as well as the target's velocity vectors 6, 10, and 14 over time. In some embodiments, the target's position at each point in time may be projected onto the virtual cable. In these and other embodiments, the target's velocity vector at each point in time may also be projected onto the virtual cable. The target's position projections (8, 12, and 16) may be calculated as an intersection between a line perpendicular to the virtual cable including the target's position (5, 9, and 13). For example, first target location 5 may be projected onto the first line 1-2 at point 8. Similarly, the second target location 9 may be projected onto the second line 2-3 at point 12. The third target location 13 may be projected onto the second line 2-3 at point 16.

The target's velocity vector projections (7, 11, and 15) may be calculated as an intersection between a line perpendicular to the target's velocity vector (6, 10, and 14) including the virtual cable. In some embodiments, the target velocity, t vel, may be filtered and approximated over a particular time period. The first target velocity vector 6 may be projected onto the first line 1-2 at point 7. Similarly, the second target velocity vector 10 may be projected onto the second line 2-3 at point 11. The third target velocity vector 14 may be projected onto the second line 2-3 at point 15.

In some embodiments, when the target's velocity projection is located farther along the direction of the virtual cable (considering the beginning of the virtual cable to be 1 and the end of the virtual cable to be 3) than the target's position projection, the target's velocity projection may be selected as the calculated position of the autonomous vehicle. For example, when the target is at the first target location 5, the first velocity vector projection 7 is ahead of the first position projection 8. The set position of the autonomous vehicle may be position 7 instead of position 8. Similarly, when the target is at the third target location 13, the third velocity vector projection 15 is ahead of the third position projection 16. The calculated position of the autonomous vehicle may be position 15 instead of position 8. In some embodiments, when the target's position projection is located farther along the direction of the virtual cable than the target's velocity projection, the target's position projection may be selected as the calculated position of the autonomous vehicle. For example, when the target is at the second target location 9, the second position projection 12 is ahead of the second velocity vector projection 11. The calculated position of the autonomous vehicle may be position 12 instead of position 11.

In some embodiments, the calculated position of the autonomous vehicle may be adjusted based on the distance between the target velocity projection and the target position projection. For example, in some embodiments, the calculated position of the autonomous vehicle may be determined based on the maximum distance forward from the target position projection. For example, when the target is at the third target location 13, the distance between the target position projection 16 and the target velocity vector projection 15 may exceed the maximum distance forward. The calculated position of the autonomous vehicle may be changed from the target velocity vector projection 15 to an adjusted autonomous vehicle calculated position 17, which may be located at a distance of the maximum distance forward from the target position projection 16. Alternatively or additionally, the calculated position of the autonomous vehicle may be modified based on the offset position of the autonomous vehicle relative to the target. For example, the calculated position of the autonomous vehicle when the target is at the first target location 5, point 7, may be adjusted forwards or backwards along the virtual cable based on the offset position.

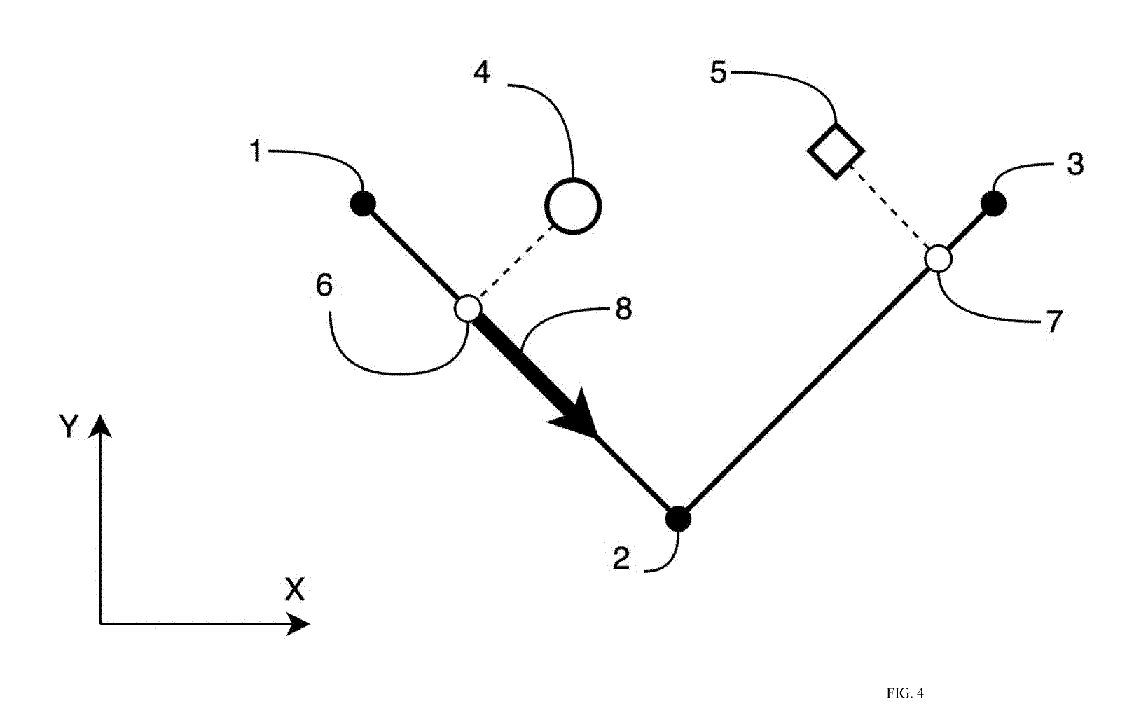

FIG. 4 illustrates a diagram representing an example embodiment related to generating a velocity vector magnitude. FIG. 4 illustrates a first line 1-2 and a second line 2-3, referred to collectively or individually as the virtual cables, that are formed by first, second, and third set locations, 1, 2, and 3, respectively. In some embodiments, the first line 1-2 and the second line 2-3 may correspond to the first line 1-2 and the second line 2-3 f FIG. 3, respectively. FIG. 4 further illustrates a current autonomous vehicle position 4, a target position 5, an autonomous vehicle on-the-line position 6, an autonomous vehicle calculated position 7, and a calculated velocity vector magnitude 8. In some embodiments, the velocity vector magnitude 8 may be determined based on a distance between the current autonomous vehicle position 4 and the autonomous vehicle calculated position 7.

In some embodiments, the on-the-line position 6 of the autonomous vehicle may be determined as a point of intersection between the closest virtual wire to the autonomous vehicle and a perpendicular line between the current autonomous vehicle position 4 and the closest virtual wire. For example, the closest virtual wire may be the first line 1-2. The intersection of a line perpendicular to the first line 1-2 that includes the current autonomous vehicle position 4 may be the autonomous vehicle on-the-line position 6. Alternatively or additionally, in some embodiments, the on-the-line position 6 of the autonomous vehicle may be determined in other ways.

In some embodiments, the autonomous vehicle calculated position 7 may be obtained in a manner similar to that discussed above with reference to FIG. 3. Alternatively or additionally, in some embodiments, the autonomous vehicle calculated position 7 may be determined as a point of intersection between the closest virtual wire and a perpendicular line between the target position 5 and the closest virtual wire. For example, the closest virtual wire may be the second line 2-3. The intersection of a line perpendicular to the second line 2-3 that includes the target position 5 may be the autonomous vehicle calculated position 7. In some embodiments, the autonomous vehicle calculated position 7 may be determined based on the virtual wire configuration, the target position 5, the target velocity vector, historical data associated with the target position 5 and the target velocity vector, and other variables associated with the virtual wire.

In some embodiments, a travel distance between the on-the-line position 6 and the calculated position 7 may be determined. For example, in some embodiments, the travel distance may include a distance along the virtual wire from the on-the-line position 6 to the calculated position 7. For example, the travel distance may include the sum of the distance from the on-the-line position 6 to the second point 2 and the distance from the second point 2 to the calculated position 7.

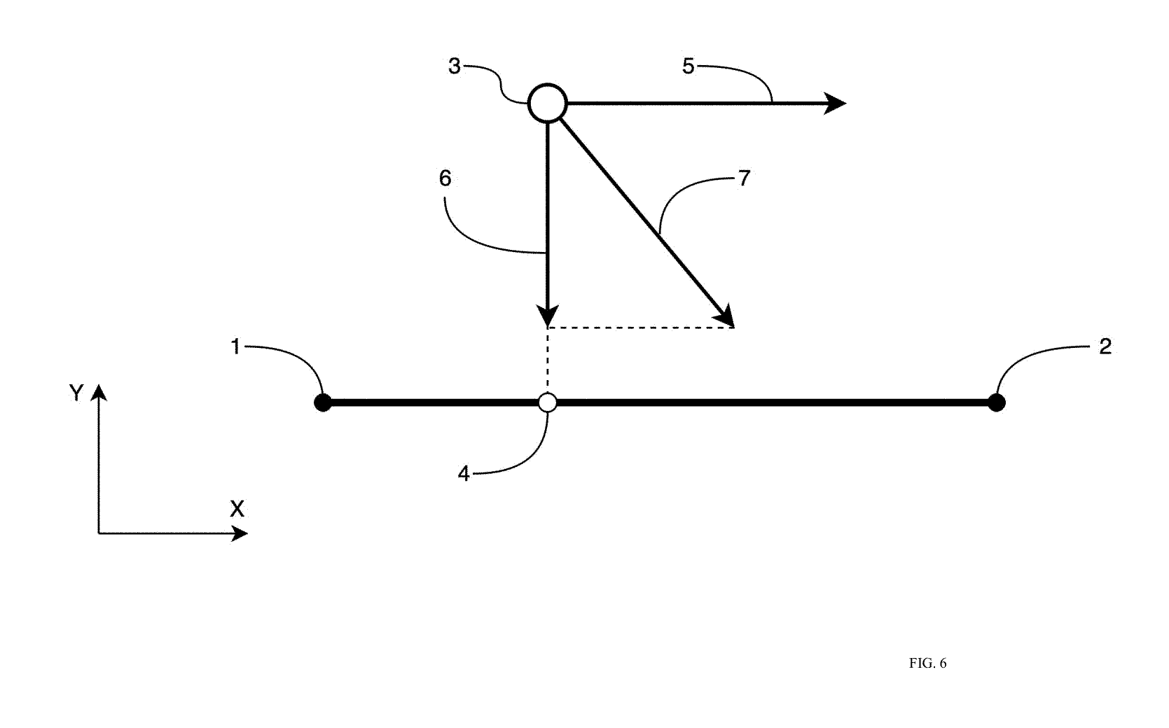

In some embodiments, the velocity vector magnitude 8 may be calculated as a function of the travel distance, Velocity vector magnitude=f (travel distance). In some embodiments, the function may be a linear function, Velocity vector magnitude=j×travel distance , where j is a constant. Alternatively or additionally, in some embodiments, the function may be based on a proportional-integral-derivative (PID) controller or a different algorithm. In some embodiments, the function may include a feed forward based on the target velocity. For example, in some embodiments, as the target velocity increases, the velocity vector magnitude 8 may also increase. In some embodiments, the calculated velocity vector magnitude 8 may be modified based on dynamic capabilities of the autonomous vehicle. For example, in some embodiments, the autonomous vehicle may have a maximum speed and/or a maximum acceleration. In these and other embodiments, the calculated velocity vector magnitude 8 may be modified to not exceed the capabilities of the autonomous vehicle. In some embodiments, the velocity vector magnitude 8 may be a velocity vector with a direction parallel to the direction of the virtual cable including the on-the-line position 6. In some embodiments, the velocity vector magnitude 8 may be used to generate a velocity vector, as discussed below with respect to FIG. 6.

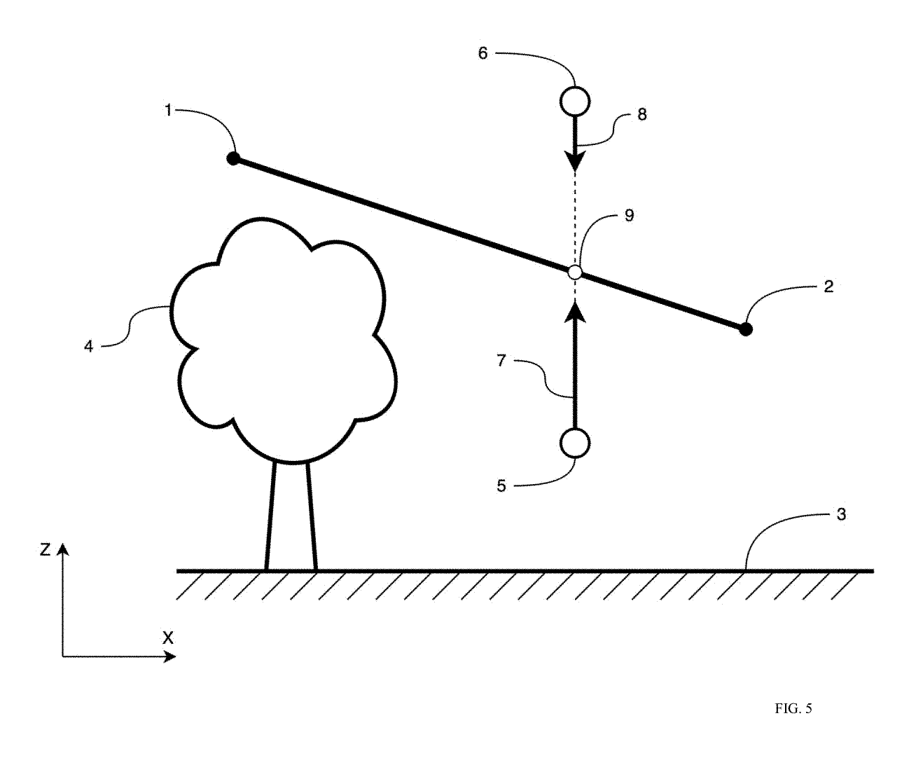

FIG. 5 illustrates a diagram representing an example embodiment related to generating a velocity vertical component correction. FIG. 5 illustrates a first line 1-2 of a virtual cable that is formed by a first and second set locations. In some embodiments, the first line 1-2 may correspond to the first line 1-2 of FIG. 3. FIG. 5 further illustrates the ground 3, an obstacle 4, a first example position 5 of an autonomous vehicle below the first line 1-2, a second example position 6 of the autonomous vehicle above the first line 1-2, a first calculated vertical line gravity component 7 based on the first example position 5, a second calculated vertical line gravity component 8 based on the second example position 6, and an intersection 9 between the first line 1-2 and a vertical line between the first example position 5 and the second example position 6.

In some embodiments, generating the velocity vertical component correction may help the autonomous vehicle to avoid the ground 3 and obstacles 4. In some embodiments, the virtual cable, including the first line 1-2, may represent a lower safe boundary for the autonomous vehicle. For example, the target following mode may attempt to control the autonomous vehicle and direct the autonomous vehicle to remain above the first line 1-2 instead directing the autonomous vehicle to move below the first line 1-2. In these and other embodiments, it may be considered safe for the autonomous vehicle to be above the first line 1-2 and it may be considered unsafe for the autonomous vehicle to be below the first line 1-2. Thus, when the autonomous vehicle is in the first example position 5 it may be considered in an unsafe position and when the autonomous vehicle is in the second example position 6 it may be considered in a safe position. In some embodiments, the vertical component of a velocity vector of the autonomous vehicle in the first example position 5 may be controlled more aggressively than the vertical component of the velocity vector in the second example position 6. In some embodiments, the autonomous vehicle may be subjected to a gravitational force from the Earth, which may pull the autonomous vehicle downwards below the first line 1-2 and may help the autonomous vehicle accelerate downwards.

In some embodiments, the vertical component of the velocity vector of the autonomous vehicle may be calculated based on a vertical distance between the first line 1-2 and the position of the autonomous vehicle. In some embodiments, the vertical distance may be a positive number when the autonomous vehicle is above the first line 1-2 and the vertical distance may be a negative number when the autonomous vehicle is below the first line 1-2. Alternatively or additionally, in some embodiments, the vertical distance may be a negative number when the autonomous vehicle is above the first line 1-2 and the vertical distance may be a positive number when the autonomous vehicle is below the first line 1-2. In some embodiments, the vertical line gravity vector may be calculated as a function of the vertical distance, Vertical line gravity=f (vertical distance . In some embodiments, the function may be a linear function, Vertical line gravity=k×vertical distance, where k is a constant. Alternatively or additionally, in some embodiments, the function may be based on a PID controller or a different algorithm. In some embodiments, the function may differ depending on whether the vertical distance is greater than zero or less than zero. In some embodiments, the vertical line gravity vector may be used in the velocity vector calculation.

FIG. 6 illustrates a diagram representing an example embodiment related to generating a velocity vector. FIG. 6 illustrates a first line 1-2 of a virtual cable that is formed by a first and second set locations, 1 and 2, respectively. In some embodiments, the first line 1-2 may correspond to the first line 1-2 of FIG. 3. FIG. 6 further illustrates the current autonomous vehicle position 3, a closest position 4 from the autonomous vehicle to the virtual cable, the velocity vector magnitude 5, a line gravity vector 6, and a calculated velocity vector 7.

In some embodiments, the velocity vector 7 may be determined based on the distance between the current autonomous vehicle position 3 and the virtual cable, the distance 3-4. For example, the autonomous vehicle may be directed to decrease the distance between the autonomous vehicle and the virtual cable. The velocity vector 7 provided to the autonomous vehicle may be configured to direct the autonomous vehicle in a direction towards the virtual cable.

In some embodiments, the line gravity vector 6 may be calculated based on the distance between the first line 1-2 and the position 3 of the autonomous vehicle. In some embodiments, the line gravity vector 6 may be calculated as a function of the distance, Line gravity=f(distance). In some embodiments, the function may be a linear function, Line gravity=1×distance , where 1 is a constant. Alternatively or additionally, in some embodiments, the function may be based on a PID controller or a different algorithm. In some embodiments, the vertical component of the line gravity vector 6 may adjusted based on the vertical line gravity described above with reference to FIG. 5.

In some embodiments, the velocity vector 7 may be determined based on the line gravity vector 6 and the velocity vector magnitude 5. For example, in some embodiments, the velocity vector magnitude 5 may be rotated to form a right triangle with the line gravity vector 6, as displayed in FIG. 6. Alternatively or additionally, in some embodiments, the velocity vector magnitude 5 and the line gravity vector 6 may be combined in other ways to generate the velocity vector 7.

In some embodiments, the velocity vector 7 may be modified based on dynamic capabilities of the autonomous vehicle and based on the current velocity vector of the autonomous vehicle, a previous velocity vector setpoint, and other properties. For example, in some embodiments, the velocity vector 7 may be modified based on physical capabilities of the autonomous vehicle. For example, the magnitude of the velocity vector 7 may be modified based on a maximum speed of the autonomous vehicle. Alternatively or additionally, in some embodiments, the velocity vector 7 may be modified based on external forces and conditions, such as the direction and speed of the wind, the battery voltage of the battery of the autonomous vehicle, safety concerns, and other variables. Alternatively or additionally, in some embodiments, the velocity vector 7 may be calculated as a transformation function based on the previous velocity vector setpoint and the velocity vector 7. For example, Current velocity vector setpoint =F(previous velocity vector setpoint, velocity vector), where F is a transformation function which may function to transform the previous velocity vector setpoint into the velocity vector 7 instantly or apply partial transformation to help the velocity transformation occur smoothly over a period of time. In some embodiments, the current velocity vector setpoint may be provided to a velocity control algorithm of the autonomous vehicle and may be used to set the velocity of the autonomous vehicle.

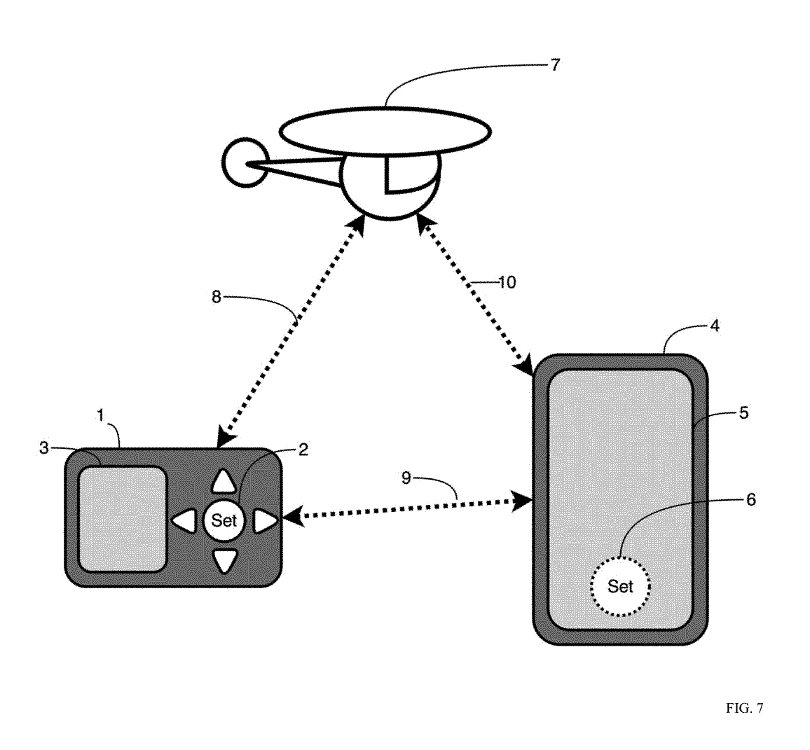

FIG. 7 illustrates a diagram representing an example environment related to generating a 3D line on a user device. In some embodiments, the environment related to generating the 3D line or virtual cable for the autonomous vehicle may include a remote control device 1, a mobile phone 4, and an autonomous vehicle 7. In some embodiments, there may be data synchronization links 8, 9, and 10 between the remote control device 1 and the autonomous vehicle 7, the remote control device 1 and the mobile phone 4, and the mobile phone 4 and the autonomous vehicle 7, respectively. The remote control device 4 may include a button 2 to set a line point and a screen 3. The mobile phone 4 may include a screen 5. An application running on the mobile phone 4 may include a software button 6 to set a line point.

In some embodiments, the 3D line for the autonomous vehicle may be generated by traveling to each point for the 3D line and pressing the button 2 on the remote control device 4 and/or by pressing the software button 6 on the mobile phone 4. For example, a user may travel to a first point location. The remote control device 1 and/or the mobile phone 4 may use global positioning sensors to locate its coordinates. The user may push the button 2 or the software button 6 to set the starting point of the line. In some embodiments, a user interface on the screen 3 or the screen 5 may request the user to enter or adjust an altitude value of this point. In some embodiments, the user interface may also request the user to accept or reject saving this point. The user may travel to another point location and repeat the process to generate other points for the virtual cable. After entering all points of the virtual cable, the user may use the user interface to save the 3D line and assign a name to it. The 3D line may be saved in the memory of the remote control device 1 or mobile device 4. Alternatively or additionally, in some embodiments, the 3D line may be saved in memory of the autonomous vehicle, in a cloud storage device, and/or in other locations.

In some embodiments, the 3D line for the autonomous vehicle may be generated by piloting the autonomous vehicle 7 to each line point. For example, the user may direct the autonomous vehicle 7 to a first point using the remote control device 1 and/or the mobile device 4. When the autonomous vehicle 7 reaches the first point, the user may use the remote control device 1 and/or the mobile device 4 to save the current location of the autonomous vehicle 7 as the first point for the virtual cable. In some embodiments, the autonomous vehicle 7 may include global positioning sensors, barometric pressure sensor, and/or rangefinder sensors such as sonar, LIDAR, or another sensor to measure its absolute altitude or relative altitude above the ground surface and save it as the altitude of the first point. The user may direct the autonomous vehicle 7 to another point and repeat the process to generate other points for the virtual cable. After entering all points of the virtual cable, the user may use the user interface to save the 3D line and assign a name to it. The 3D line may be saved in the memory of the remote control device 1 or mobile device 4. Alternatively or additionally, in some embodiments, the 3D line may be saved in memory of the autonomous vehicle 7, in a cloud storage device, and/or in other locations. In some embodiments, the 3D line data may be synchronized between the remote control device 1, the mobile device 4, and the autonomous vehicle 7.

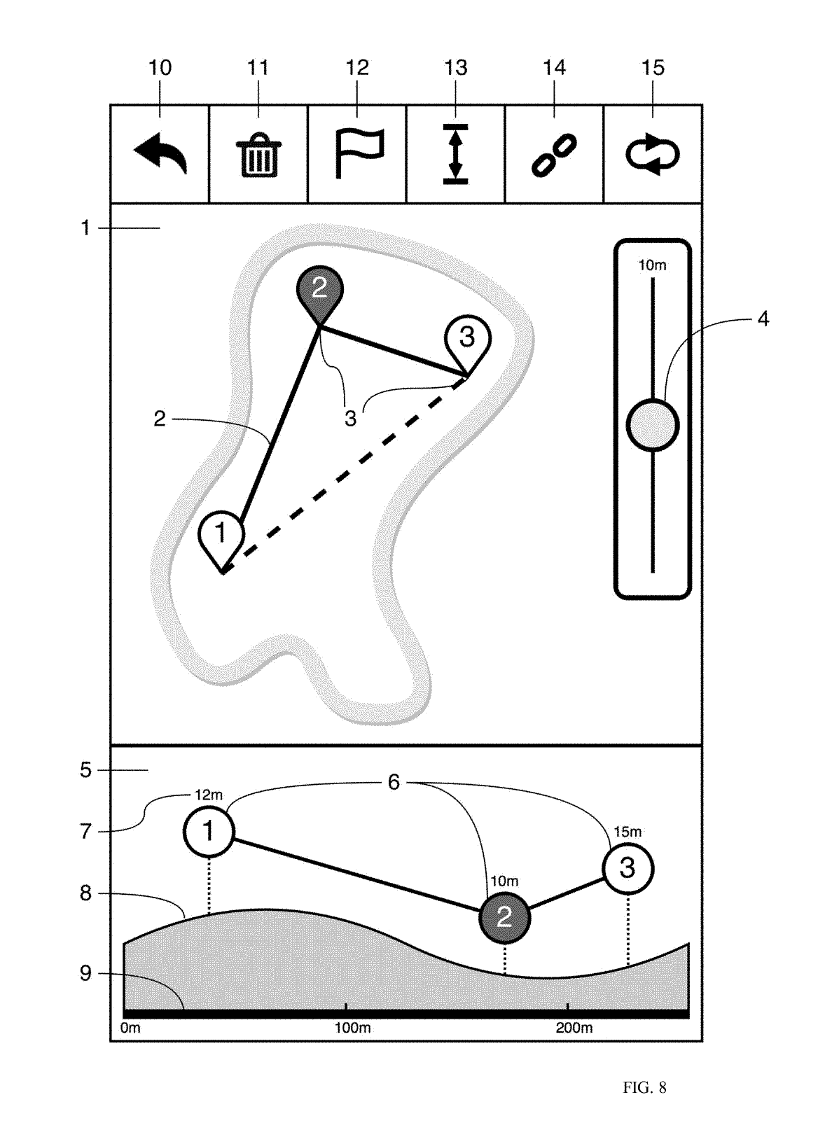

FIG. 8 illustrates a diagram representing another example environment related to generating a 3D line on a user device. The environment may include a line draw area 1, one or more points 3 connected by lines 2, a control bar 4 to adjust the altitude of a point 3, a terrain graph 5 of a user interface including the points 6 of the virtual cable, elevations 7 of the points 6, terrain elevation 8, and a distance scale 9. Additionally or alternatively, the environment may include an undo button 10, a delete button 11, a reorder points button 12, a show/hide toolboxes button 13, a subdivide line button 14, and a closed loop option 15.

In some embodiments, a user may generate a virtual cable using the environment. For example, the user may place multiple points 3 on the map in the line draw area 1. In some embodiments, tapping an area in the line draw area 1 may add a new point 3 and may automatically connect the new point 3 with the previous point 3. In some embodiments, tapping on a point 3 may select the point 3. The user may drag the point 3 to a new location on the line draw area 1. In some embodiments, dragging in an area of the line draw area 1 without a point 3 may move the map background and points 3 displayed in the line draw area 1. In some embodiments, pinching in and out may change the background map zoom. In some embodiments, when a point 3 is selected, the user may use the control bar 4 to adjust the altitude of the selected point 3.

Additionally or alternatively, in some embodiments, one or more of the points 3 may be obtained automatically, e.g., by the autonomous vehicle and/or the control device, without the user manually inputting the points 3. In these or other embodiments, the autonomous vehicle may detect movement of the control device, such as the remote control device 1 and/or the mobile phone 4 of FIG. 7, as the control device moves to various positions. As the control device moves to various positions, the autonomous vehicle and/or the control device may associate a respective location of the control device, for example, as a first position, a second position, and a third position illustrated by the points 3. Additionally or alternatively, obtaining a first altitude of the first position, a second altitude of the second position, and a third altitude of the third position may be obtained automatically, e.g., without manual input from the user, via the autonomous vehicle and/or the control device. For example, the autonomous vehicle and/or the control device may determine respective altitude values of the autonomous vehicle at the first, second and third positions as the first altitude, the second altitude, and the third altitude.

In these or other embodiments, obtaining the first position, the second position, the third position, the first altitude, the second altitude, and the third altitude may occur during an initialization process. The initialization process may take affect or be performed, for example, during a warm-up lap, a practice run, a walk-through, or other suitable time period. During the initialization process, a three-dimensional mapping of a flight environment of the autonomous vehicle may be obtained. For example, the three-dimensional mapping may include one or more obstacles such as the obstacle 4 of FIG. 5 and/or terrain topography, for example, of the ground 3 of FIG. 5. In these or other embodiments, the three-dimensional mapping may indicate safe zones and/or unsafe zones in which the autonomous vehicle accordingly can fly, should fly, should not fly, and/or cannot fly. Additionally or alternatively, during the initialization process, the control device may be instructed or otherwise instruct that movement of the control device be slowed until the initialization process is complete. For example, the control device may be instructed or otherwise instruct that movement of the control device be slowed to a first speed that is slower than a second speed after the initialization process is complete. Thus, in some embodiments, it may be advantageous to perform the initialization process during a warm-up lap, a practice run, a walk-through, or other suitable time period such that the control device moves at a slower speed relative to competition speed, race speed, etc.

In other embodiments, one or more of the points 3 may be obtained automatically by the control device, without the user manually inputting the points 3 and without the autonomous vehicle. As the control device moves to various positions, the control device may associate a respective location of the control device, for example, as the first position, the second position, and the third position illustrated by the points 3. Additionally or alternatively, obtaining a first altitude of the first position, a second altitude of the second position, and a third altitude of the third position may include automatically setting, e.g., without manual input from the user, a default altitude. In these or other embodiments, there may be no three-dimensional mapping of the flight environment. Thus, in some embodiments, no information may be known about the flight environment. However, when obtaining the points 3, more realistic information of the target may be obtained with respect to speed, acceleration, etc. of the target. For example, by foregoing an initialization process and three-dimensional mapping that incorporates the autonomous vehicle at reduced speeds, the target may be free to move in a manner similar to competition speed, race speed, etc. while the control device obtains the first position, the second position, and so forth. In these or other embodiments, after the control device obtains the points 3, information regarding the points 3 may be uploaded or sent to the autonomous vehicle.

In other embodiments, obtaining the points 3 may proceed as follows. For example, a wearable device such as the control device and/or a user device may be powered on and move with the target to various locations and associate a respective location of the control device and/or the user device as the first position, the second position, the third position, and so forth. In so doing, e.g., during a first lap or run, the control device and/or the user device may obtain movement information of the target. For example, the control device and/or the user device may obtain metadata that includes a path, direction, speed, acceleration, G-force, descents, ascents, etc. of the target.

Concurrently with the control device and/or the user device obtaining position and movement information, the autonomous vehicle may obtain a flight trajectory. For example, as the movement information and the first, second, and third positions are obtained by the control device and/or the user device, the flight trajectory may be generated using such data. In these or other embodiments, to generate the flight trajectory, the autonomous vehicle may perform a three-dimensional mapping of the flight environment concurrently with the control device and/or the user device obtaining position and movement information of the target. For example, the autonomous vehicle may, while moving at a slower speed than the target, map objects and terrain of the flight environment. Thus, in some embodiments, the target may finish the lap or run earlier than the autonomous vehicle, resulting in a time gap between completion of the lap or run by the target and the autonomous vehicle.

Alternatively, the autonomous vehicle may be instructed to three-dimensionally map the flight environment after the control device and/or the user device obtains the first, second, and third positions. For example, any data obtained by the control device and/or the user device may be uploaded to the autonomous device, which can subsequently proceed to three-dimensionally map the flight environment with or without the control device and/or the user device leading the autonomous vehicle.

Once the three-dimensional mapping of the flight environment is obtained, data of the three-dimensional mapping of the flight environment may be combined with data obtained by the control device and/or user device that includes position data and movement data of the target to generate a flight trajectory for the autonomous vehicle. The flight trajectory may be specific to the run or lap taken by the target when the control device and/or the user device obtained the position data and the movement data. Additionally or alternatively, the flight trajectory may be specific to the run or lap of which the three-dimensional mapping includes. In other embodiments, the flight trajectory may be generated without any data of the three-dimensional mapping. In such embodiments, an unsafe zone or a no-fly zone may not be indicated without the data of the three-dimensional mapping. Thus, in some embodiments, a flight trajectory generated without data of the three-dimensional mapping map take place in an area without objects or terrain which might cause the autonomous vehicle to crash.

In some embodiments, lines between the points 3 may be automatically created, e.g., via processing within the control device, a user device, the autonomous vehicle, and/or cloud computing. The lines between the points 3 may correspond to a three-dimensional flight path or flight trajectory of the autonomous vehicle. In some embodiments, due to automatic line connection between the points 3, a three-dimensional flight path may be improved compared to a flight path as manually assembled by a user. For example, the automatic line connection by the autonomous vehicle may smooth movement of the control device or more seamlessly transition between the points 3 in contrast to manual manipulation that may result in poor video quality, e.g., due to sharp turns, sudden increases or decreases in elevation, etc. In these or other embodiments, the lines between the points three may change as a function of time. For example, after a first run, an improved flight path may be determined based on additional information obtained during the first run.

In these or other embodiments, the points 3 and/or the lines connecting the points 3 may be configured to be shared with one or more user devices. For example, a first user may send via a first user device the points 3 and/or the lines connecting the points 3 to a second user device of a second user. In this manner, a second autonomous vehicle of the second user may be enabled to fly the three-dimensional flight path obtained by a first autonomous vehicle of the first user without an initialization process. For example, a three-dimensional flight path of an autonomous vehicle used by one broadcasting station in an Olympic halfpipe course may be made shared with other broadcasting stations such that autonomous vehicles associated with the other broadcasting stations may fly the same three-dimensional flight path in a repeatable manner. In another example, a local course-professional may have obtained with an autonomous vehicle, a three-dimensional flight path with high viewership reviews and/or ratings. Other individuals may desire to purchase the three-dimensional flight path created by the local course-professional.

Additionally or alternatively, in some embodiments, the user may manually select a point 6 in the terrain graph 5. In these and other embodiments, the points 6 in the terrain graph 5 may correspond to similarly labeled points 3 in the line draw area 1. In these and other embodiments, a user may drag a point 6 in the terrain graph 5 up or down to modify the altitude 7 of the selected point 6. In some embodiments, the user may adjust the altitude 7 of the points 6 in relation to the terrain elevation 8 and relative to each other.

In some embodiments, the user may use the control buttons such as the undo button 10, the delete button 11, the reorder points button 12, the show/hide toolboxes button 13, the subdivide line button 14, and the closed loop option 15 for ease of generating the virtual cable. For example, the undo button 10 may undo the most recent action taken by the user, the delete button 11 may delete a selected point 3 and/or point 6, the reorder points button 12 may allow a user to change the order of the points 3 and/or the points 6, the show/hide toolboxes button 13 may show/hide the terrain graph 5 and/or the control bar 4, the subdivide line button 14 may divide an existing line, such as the line 2, into separate lines 2, and the closed loop option 15 may toggle the virtual cable between a closed loop and an open configuration. For example, the dashed line between the point (1) and the point (3) may indicate that the closed loop option is toggled.

Additionally or alternatively, any of the first position, the second position, the third position, the first altitude, the second altitude, and the third altitude may be adjustable according to user preferences after the initialization process discussed above is complete. For example, the first position, the second position, the third position, the first altitude, the second altitude, and the third altitude may be adjustable via haptic input at the user interface, the haptic input including one or more of a tap, swipe, drag, push, pinch, spread, hold, and any other suitable haptic input. In these or other embodiments, to adjust any of the first position, the second position, the third position, the first altitude, the second altitude, and the third altitude, the user may select a corresponding set point via the haptic input.

In some embodiments, the virtual cable generated using the environment may be modified during a preview flight mode of the virtual cable. In these and other embodiments, the autonomous vehicle may be directed to the first point and/or any point on the virtual cable. When the autonomous vehicle reaches the particular point, the user may use the remote control device and/or the mobile phone to modify the particular point. For example, the user may adjust the position and/or the altitude of the autonomous vehicle and overwrite the particular point with data about the current location of the autonomous vehicle. The user may direct the autonomous vehicle to another particular point of the virtual cable and make similar adjustments. After modifying the virtual cable, the adjustments to the virtual cable may be synchronized between the autonomous vehicle, the remote control device, and/or the mobile phone.

In some embodiments, the virtual cable generated using the environment may be modified automatically using altitude correction. For example, the user may direct the autonomous vehicle to initiate the flight along the virtual cable to the first point. Upon reaching the first point, the autonomous vehicle may use its onboard sensors (sonar, LIDAR, etc.) to measure the actual distance to ground surface from the position of the autonomous vehicle. If the actual distance is lower or higher than the saved altitude of the first point, the autonomous vehicle may apply corrections to the altitude (increase or decrease) of the first point and/or multiple points of the line.

Alternatively or additionally, in some embodiments, the virtual cable generated using the environment may be modified automatically during the line preview mode. For example, the autonomous vehicle may be configured to use its onboard sensors (sonar, LIDAR, etc.) to measure the distance to the ground surface. If the measured distance to the ground is greater than or less than the saved altitude of the point, the autonomous vehicle may apply correction to the altitude of the point. Additionally or alternatively, during the travel of the autonomous vehicle between two points, the autonomous vehicle may add new points to the virtual cable to maintain an altitude over the ground. For example, between points 1 and 2, the autonomous vehicle may set a new point with altitude over the ground that is the average of the altitude of the first point and the second point.

Alternatively or additionally, in some embodiments, the virtual cable generated using the environment may be modified automatically during the target following mode. When flying along the virtual cable and following the target, the autonomous vehicle may use its onboard sensors (sonar, LIDAR, etc.) to measure the distance to ground surface. If the measured distance is lower than a preset “safe” altitude, the autonomous vehicle may adjust the altitude of one or more points on the virtual cable to be higher.

The embodiments described herein may include the use of a special-purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general-purpose or special-purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable media.

Computer-executable instructions comprise, for example, instructions and data which cause a general-purpose computer, special-purpose computer, or special-purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general-purpose hardware (e.g., computer-readable media, processing devices, etc.) of the computing system. In some embodiments, the different components, modules, engines, and services described herein may be implemented as objects or processes that execute on the computing system (e.g., as separate threads).

While some of the system and methods described herein are generally described as being implemented in software (stored on and/or executed by general-purpose hardware), specific hardware implementations or a combination of software and specific hardware implementations are also possible and contemplated. In this description, a “computing entity” may be any computing system as previously defined herein, or any module or combination of modulates running on a computing system.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method for an autonomous vehicle to follow a target, the method comprising:
obtaining a three dimensional virtual cable for an autonomous vehicle;
obtaining a position and a velocity of a target;
obtaining a position of an autonomous vehicle;
determining a calculated position of the autonomous vehicle based on the position and velocity of the target and based on the three dimensional virtual cable;
determining a velocity vector magnitude for the autonomous vehicle based on the calculated position, the position of the autonomous vehicle, and the three dimensional virtual cable;
determining a velocity vector for the autonomous vehicle based on the velocity vector magnitude and a line gravity vector; and
adjusting a velocity and a direction of the autonomous vehicle based on the velocity vector.

2. The method of claim 1, wherein determining the calculated position comprises:
identifying a forward direction with respect to the three dimensional virtual cable;
projecting the position of the target onto the three dimensional virtual cable;
projecting the velocity of the target onto the three dimensional virtual cable; and
in response to the projection of the velocity being more forward than the projection of the position, selecting the projection of the velocity as the calculated position.

3. The method of claim 2, further comprising adjusting the calculated position based on a target offset distance and a maximum forward distance.

4. The method of claim 1, wherein the line gravity vector comprises a vertical component and a horizontal component, the vertical component based on a vertical distance between the three dimensional virtual cable and the position of the autonomous vehicle and the horizontal component based on a horizontal distance between the three dimensional virtual cable and the position of the autonomous vehicle.

5. The method of claim 1, wherein the determining the velocity vector comprises rotating the velocity vector magnitude based on the line gravity vector.

6. A method to generate a three dimensional virtual cable for an autonomous vehicle, the method comprising:
obtaining a first position of a first set point for the three dimensional virtual cable;
obtaining a first altitude for the first set point;
obtaining a second position for a second set point;
obtaining a second altitude for the second set point;
connecting the first set point with the second set point with a first line;
obtaining a third position for a third set point;
obtaining a third altitude for the third set point;
connecting the second set point with the third set point with a second line; and
storing the first set point with the first position and the first altitude, the second set point with the second position and the second altitude, the third set point with the third position and the third altitude, the first line, and the second line in one or more computer-readable media.

7. The method of claim 6, wherein obtaining the first position, the second position, and the third position comprises directing the autonomous vehicle to the first position, the second position, and the third position, respectively, and providing a signal to the autonomous vehicle to obtain a current location of the autonomous vehicle as the first position, the second position, and the third position and wherein obtaining the first altitude, the second altitude, and the third altitude comprises directing the autonomous vehicle to the first altitude, the second altitude, and the third altitude, respectively, and providing a signal to the autonomous vehicle to obtain a current altitude of the autonomous vehicle as the first altitude, the second altitude, and the third altitude.

8. The method of claim 6, wherein obtaining the first position, the second position, and the third position comprises moving a control device communicatively coupled with the autonomous vehicle to the first position, the second position, and the third position, respectively, and providing a signal to the control device to obtain a current location of the control device as the first position, the second position, and the third position and wherein obtaining the first altitude, the second altitude, and the third altitude comprises entering an altitude value into the control device as the first altitude, the second altitude, and the third altitude.

9. The method of claim 6, wherein obtaining the first position, the second position, and the third position comprises selecting a position on a map displayed on a control device communicatively coupled with the autonomous vehicle as the first position, the second position, and the third position and wherein obtaining the first altitude, the second altitude, and the third altitude comprises moving the first position, the second position, and the third position on a terrain map displayed on the control device to a particular altitude value as the first altitude, the second altitude, and the third altitude.

10. The method of claim 6, wherein:
obtaining the first position, the second position, and the third position comprises moving a control device communicatively coupled with the autonomous vehicle to the first position, the second position, and the third position, respectively, and the autonomous vehicle automatically obtains a current location of the control device as the first position, the second position, and the third position; and
obtaining the first altitude, the second altitude, and the third altitude comprises automatically receiving, at the control device from the autonomous vehicle, an altitude value as the first altitude, the second altitude, and the third altitude.

11. A computer-readable medium configured to store instructions that when executed by an autonomous vehicle are configured to cause or direct the autonomous vehicle to perform the method of claim 1.

12. A system comprising:
one or more processors of a control device; and
an autonomous vehicle communicatively coupled with the control device, the one or more processors of the control device configured to perform or control performance of operations comprising:
obtaining a first position of a first set point for a three dimensional virtual cable;
obtaining a first altitude for the first set point;
obtaining a second position for a second set point;
obtaining a second altitude for the second set point;
connecting the first set point with the second set point with a first line;
obtaining a third position for a third set point, the obtaining the first position, the second position, and the third position based on the control device being respectively positioned at the first position, the second position, and the third position;
obtaining a third altitude for the third set point;
connecting the second set point with the third set point with a second line; and
storing the first set point with the first position and the first altitude, the second set point with the second position and the second altitude, the third set point with the third position and the third altitude, the first line, and the second line in one or more computer-readable media.

13. The system of claim 12, wherein obtaining the first position, the second position, the third position, the first altitude, the second altitude, and the third altitude occurs during an initialization process.

14. The system of claim 13, wherein during the initialization process, the control device moves at a first speed that is slower than a second speed after the initialization process is complete.

15. The system of claim 13, wherein the operations further comprise, during the initialization process, obtaining a three-dimensional mapping of a flight environment of the autonomous vehicle, the three-dimensional mapping including one or more obstacles and terrain topography.

16. The system of claim 12, wherein:
the first set point is automatically connected with the second set point with the first line; and
the second set point is automatically connected with the third set point with the second line.

17. The system of claim 12, wherein the first set point, the second set point, the third set point, the first line, and the second line are configured to be shared with one or more user devices.

18. The system of claim 12, wherein:
the control device includes a user interface; and
after an initialization process, the first position, the second position, the third position, the first altitude, the second altitude, and the third altitude are adjustable within the user interface according to user preferences.

19. The system of claim 18, wherein the first position, the second position, the third position, the first altitude, the second altitude, and the third altitude are adjustable via haptic input at the user interface, the haptic input including one or more of a tap, swipe, drag, push, pinch, spread, and hold.

20. The system of claim 19, wherein obtaining the first altitude, the second altitude, and the third altitude is based on the autonomous vehicle being respectively positioned at the first altitude, the second altitude, and the third altitude.
